(19) United States
(12) Patent Application Publication
(10) Pub. No.: US 2009/0164296 A1
(43) Pub. Date: Jun. 25, 2009

(54) SCHEDULING TRANSIENT ONLINE ADVERTISEMENTS

(75) Inventor: Thomas Phan, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/961,770

(22) Filed: Dec. 20, 2007

(51) Int. Cl. G06Q 10/00; G06Q 30/00

(52) U.S. Cl. 705/10; 705/7; 705/14

(57) ABSTRACT

Methods and apparatus for providing transient advertisement for a product during a specific time period are provided. At the beginning of the time period, the product becomes available, and at the end of the time period, the product becomes unavailable. An optimal advertising period within the time period for advertising the product is determined based on historical data obtained for other products having similar features or characteristics as the product. An advertisement schedule is planned for the product, such that product advertisement is increased during the optimal advertising period. The product is advertised during the time period based on the advertisement schedule. Optionally, the optimal advertising period and/or the advertisement schedule are adjusted as needed based on the current data, such as click-through rate and/or purchase rate, obtained for the product since the product advertisement begins.

### BACKGROUND OF THE INVENTION

The present invention relates to methods, apparatus, and computer program products for scheduling transient ads for products that have specific viable selling windows. More specifically, the present invention relates to determining optimal periods for advertising such products in order to increase and preferably maximize advertisement effectiveness.

Cost Per Action, or CPA, is an online advertising model where the advertiser pays the ad publisher for each specific user action linked to the advertisement. The users are the targeted audience of the advertisement, and the user actions may include a click on an ad, a purchase or acquisition of a product, a form submission, a request for product information, and so on. Each particular type of user action may have a different price. For example, the advertiser may pay more for an acquisition of the product than a click on the ad.

From the ad publisher's point of view, in order to generate higher revenue in CPA advertising campaigns, it is desirable that the ads produce as many user actions as possible. User actions are measured via metrics such as, for example, click-through rate (CTR, obtained by dividing the number of users who click on an ad on a web page by the number of times the ad is delivered, i.e., the number of impressions) or acquisition rate (obtained by dividing the number of purchases of a product by the number of user clicks on an ad of the product). Factors that affect the CTR and the acquisition rate include, for example, the desirability of the advertisement and the demographical makeup of the targeted advertising audience. Another important factor is the scheduling of the ads, i.e., the time period for delivering the ads to the users.

Although advertisement scheduling is important to all types of advertising campaigns, it is especially so for transient ads for products having specific viable selling periods. Such products are typically characterized by a deadline or an expiration date. For example, tickets to a concert have a deadline on the day the concert is held, since no one is likely to buy a concert ticket after the concert itself is completed. Thus, the viable selling period for the concert tickets is from the time the tickets first become available for sale to the time of the concert. Similarly, plane tickets to a particular flight have a deadline at the time the flight takes off, and the viable selling period for such plane tickets is from the time the tickets become available to the time the flight takes off.

For products that have specific viable selling periods, it is important to schedule the delivery of the ads appropriately as to maximize the effectiveness of the advertisement, since the ads need to be delivered within specific time periods. Obviously, ads delivered after the product's deadline or expiration date are meaningless. At the same time, ads delivered too early within the viable selling period may not be very effective either, because people tend to ignore events too far ahead in the future. Similarly, ads delivered too close to the end of the viable selling period may not be effective either, because people will have already made alternative plans or the remaining inventory may be too limited, undesirable, or expensive.

### SUMMARY OF THE INVENTION

Various embodiments of the present invention relates to systems and methods for scheduling transient ads for products that have specific viable selling periods. At the beginning of a viable selling period, a product becomes available, and at the end of the viable selling period, the product becomes unavailable.

According to a specific embodiment, an optimal advertising period within a viable selling period is determined for a product based on historical data associated with other products having similar features or characteristics as the product. The determination of the optimal advertising period may be further based on the demographical makeup of the targeted audience to whom the ads are to be delivered and/or the types of ads for the product. If no historical data is available for the product, then a default optimal period may be chosen. The optimal advertising period is selected to increase the effectiveness of the advertisement and generally correlates with the purchase rate curve for the type of product.

An advertisement schedule is planned for the product, such that advertising of the product is increased during the optimal advertising period in order to increase and preferably maximize the effectiveness of the advertisement. The ads are delivered based on the advertisement schedule.

Optionally, the optimal period and/or the advertisement schedule are adjusted as needed based on the current performance data, such as click-through rate and/or purchase rate, collected for the product since the advertisement of the product began. Such data reflects the actual performance of the product being advertised. And the ads are delivered, e.g., increased or decreased for specific time periods, based on the adjusted optimal period and/or the advertisement schedule.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings in which like reference numerals refer to similar elements, and in which:

FIG. 1A illustrates a sample timeline for a product that has a viable selling period.

FIG. 1B illustrates a sample purchase rate curve against the timeline for the product that has a viable selling period.

FIG. 2 illustrates a method of determining an optimal advertising period for scheduling transient ads for a product having a viable selling period.

FIG. 3 illustrates a sample system for scheduling transient ads for a product having a viable selling period.

FIG. 4 is a simplified diagram of a network environment in which specific embodiments of the present invention may be implemented.

### DETAILED DESCRIPTION OF THE INVENTION

The present invention will now be described in detail with reference to specific embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail to avoid unnecessarily obscuring the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

Certain types of products have specific viable selling periods. Generally, a viable selling period for such a product is from when the product first becomes available on the market to when the product becomes unavailable after it has been removed from the market or after the limited inventory or supply has been exhausted, i.e., the product's deadline or expiration date. A product may expire for different reasons. For example, some products may be seasonal, such as products associated with the Christmas holiday, which usually expire shortly after the end of December each year. Some products may become meaningless after a certain date, such as concert or sport event tickets, which expire once the particular event is completed.

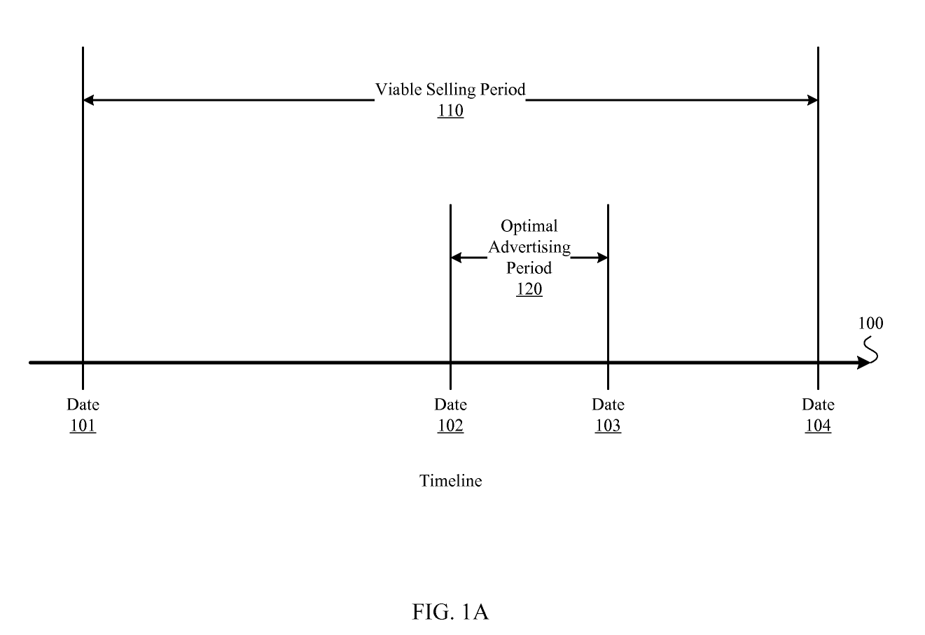

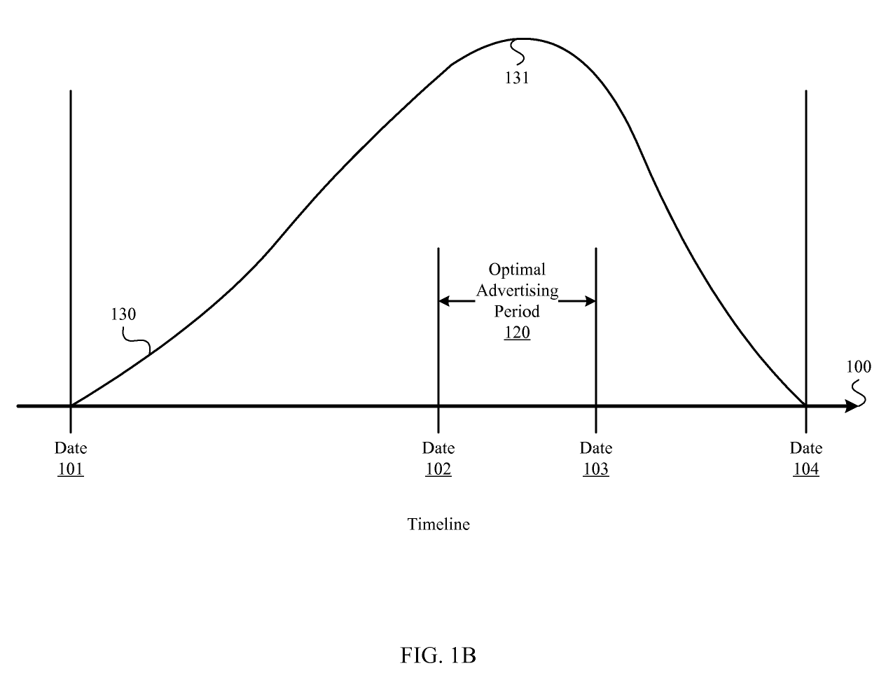

FIG. 1A illustrates a sample timeline 100 for a product that has a viable selling period. Along the timeline 100, the viable selling period 110 extends from date 101 to date 104. Date 101 is the earliest time when the product becomes available for sale, and date 104 is when the product expires and becomes unavailable. From date 101 to date 104, i.e., during the viable selling period 110, people may purchase the product. However, it is unlikely that the purchase rate for the product remains consistent throughout the entire viable selling period 110. Instead, the product purchase rate may go up and down depending on various influential factors including the characteristics of the product itself.

For example, plane tickets for a particular flight may go on sale six months to one year before the actual flight date. However, toward the beginning of the viable selling period 110, the sales for the plane tickets may be low, since not many people plan their travels so far in advance. As time goes by, more and more people may purchase the plane tickets as their travel plans become certain and the purchase rate increases accordingly. There is a period, perhaps between two weeks to six weeks before the actual flight date, during which most people purchase their plane tickets, and the purchase rate is the highest during this time period. Thereafter, the purchase rate may decline as it gets closer to the actual flight date because the tickets may become too expensive. People who do purchase tickets closer to the actual flight date are usually last-minute travelers.

FIG. 1B illustrates a sample purchase rate curve 130 against the timeline 100 for the product that has a viable selling period. The purchase rate may be calculated as the number of purchases made during a given time period, such as the number of purchases per day. The purchase rate curve 130 resembles the above plane tickets scenario and has one peak purchase period, which peaks at 131. Of course, the purchase rate curves differ for each type of product. Sometimes, there may be multiple peak purchase periods, and the peak periods may be near the beginning, the middle, and/or the end of the viable selling period 110. In another scenario, suppose there is a very popular concert and its tickets are in high demand. The sales for these concert tickets may be highest at the very beginning of the viable selling period when the tickets first become available. In fact, the tickets may be sold out after a few days, long before the concert date, i.e., the expiration date for the tickets. In this case, the purchase rate curve for the concert tickets has its peak at the very beginning of the viable selling period and quickly drops down to zero once the tickets are sold out.

Because the purchase rate curve 130 for a product goes up and down during the viable selling period 110, there is a particular period within the viable selling period 110 during which advertising the product to the consumers is particularly effective, partly because many consumers tend to be ready or willing to purchase the product during this period. This period may be referred to as the optimal advertising period 120 or the sweet spot, and is marked between date 102 and date 103 in FIGS. 1A and 1B. Usually, the optimal advertising period 120 correlates with the purchase rate curve 130, such that the optimal advertising period 120 may coincide with the peak purchase period 131 along the purchase rate curve 130 or may be slightly ahead of the peak purchase period 131.

If the optimal advertising period 120 may be determined for a product, then product advertisement during this period may be increased to increase and/or maximize its effectiveness. This may be particularly important to ad publishers conducting CPA advertising campaigns in terms of generating revenue through CPA deals. Increasing product advertisement during the product's optimal advertising period tends to result in more user actions linked to the advertisement, such as product acquisition, which in turn results in more revenue for the ad publishers. It may be beneficial to the advertisers as well. Sometimes, the advertisers may have a limited budget for a CPA advertising campaign. The advertisers may wish to have the advertising efforts concentrated during the optimal advertising period so as to receive maximum results for the money spent.

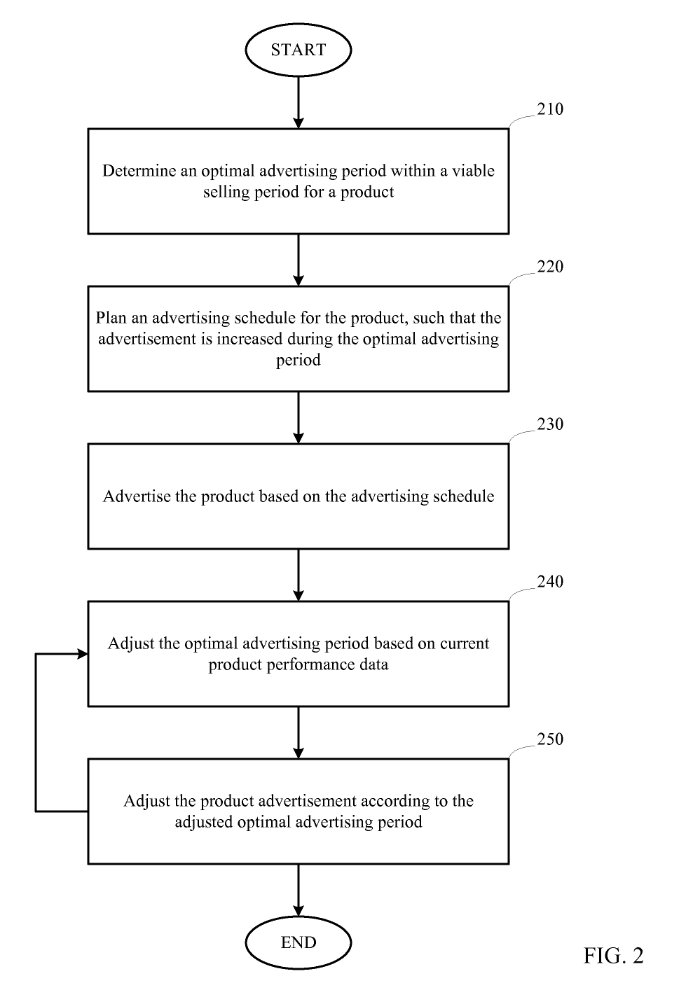

FIG. 2 illustrates a method of determining an optimal advertising period for scheduling transient ads for a product having a viable selling period. The method is described in connection with the sample product timeline 100 and product purchase rate curve 130 shown in FIGS. 1A and 1B.

At 210, an optimal advertising period within a viable selling period for a product is determined. As explained above, the optimal advertising period 120 often correlates with the peak period along the product's purchase rate curve 130. Furthermore, similar products, that is, products with same or similar features or characteristics or products belonging to the same category, tend to have similar purchase rate curves. For examples, different brands or models of MP3 players with similar specifications, such as operational functionalities, memory capacities, warranty terms, etc., often have similar purchase rate curves.

Thus, one way to determine the optimal advertising period 120 for a brand new product is to use the historical sales data associated with other similar products. Suppose tickets for a football game are about to go on sale and the ad publishers need to determine the optimal advertising period 120 for these tickets. Historical data associated with ticket sales for other football games involving the same or similar teams at the same location may be used. If the historical data shows that in the past, for this type of football games, ticket sales tend to reach its peak periods between two months to three months before the actual date of the game, then it may be reasonable to infer that the optimal advertising period for the current game is also between two months to three months before the actual game date.

In another scenario, suppose an airline wishes to conduct a promotional campaign during the Christmas to New Year holiday season, and the airline decides to set aside a certain number of plane tickets to several popular destinations for this campaign. In this case, historical data obtained from similar promotional campaigns in the past may be used to determine the optimal advertising period 120. Ticket sales data during the Christmas to New Year holiday season to the same destinations for the last several years may be used. In addition, the availability of the product inventory may also affect the determination of the optimal advertising period 120. If the airline only has a small number of plane tickets set aside for this campaign, then the optimal advertising period 120 may be relatively short, and vice versa.

The optimal advertising period 120 may be refined for a targeted audience only. For example, if an advertiser decides to conduct an ad campaign targeting a segment of the consumers that satisfy certain demographical characteristics, then the historical data may be narrowed to those types of consumers only. Suppose the product being advertised is tickets to a rock ‘n’ roll concert. The advertiser may wish to target consumers within a certain age group, such as people between the ages of 18 and 30. In this case, historical data associated with ticket sales to other concerts by the same band to people between the ages of 18 and 30 may be used to determine the optimal advertising period 120 for the tickets to this new concert. Other characteristics for the targeted audience may include geographical location, education, profession, gender, marital status, income level, hobby, etc.

In addition, the optimal advertising period 120 may be refined based on the types of ads provided by the advertisers. For example, the advertisers may have a set of ads they wish to use. In this case, the advertisers may have used these ads in the past for similar products, and such historical data may be used to determine the optimal advertising period for the new product based on how effective the ads have been in the past.

Alternatively, if no historical data associated with similar products is available, then the ad publisher may choose a default optimal advertising period as an initial determination, perhaps based on professional experience. The default optimal advertising period may be any period before or during the viable selling period.

Of course, historical data associated with other similar products is only one way to determine the optimal advertising period 120 for a product. Other types of historical data aside from purchase rate may be used as well. For example, different types of metrics may be used to determine the optimal advertising period 120, where each type of metric may include different parameters obtained from the historical data. One metric may focus on the absolute sales over time. Another metric may focus on the acceleration of purchase rate rather than the absolute purchase rate. Yet another metric may include the click-through rate or the net revenue to determine the region with the highest values of either or both. In other words, any business logic may be used to determine the optimal advertising period 120, and the selection of the business logic actually used is dependent upon the specific needs and/or requirements of the individual advertiser.

Once the optimal advertising period for the product is determined, at 220, an advertising schedule may be planned for the product, such that the amount of advertisement is increased during the optimal advertising period. How much the advertisement is increased may depend on the needs of the ad publishers, and may be adjusted as needed. For example, the ad publishers may choose to conduct a concentrated advertising campaign during the optimal advertising period 120, focusing its main advertising effort. Alternatively, the ad publishers may decide only to increase the advertisement slightly, while still providing reasonable effort for the other periods outside the optimal advertising period 120. Or, if there is a great supply of the product, then the advertisers may wish to take advantage of the optimal advertising period by saturating the amount of advertisement during this period.

At 230, the product is advertised based on the predetermined schedule. According to some embodiments, because the optimal advertising period 120 for the product is inferred based on historical data associated with other similar products or in some cases a default optimal advertising period 120 is chosen, the optimal advertising period 120 may not be as accurate as possible for the product. Once the product becomes available, actual marketing and sales data associated with the product becomes available as time goes by. At 240, the optimal advertising period may be adjusted in real-time based on the actual marketing data associated with the product itself and collected since the product has become available. For example, if the product performance data shows that the purchase rate for this product grows faster and will hit its peak before other similar products, then the optimal advertising period 120 may be moved forward, and vice versa. Or, if the product performance data shows that the purchase rate for this product will remain at its peak for a longer period than other similar products, then the optimal advertising period 120 may be extended, and vice versa.

At 250, the advertisement schedule for the product may also be adjusted according to the adjusted optimal advertising period 120, e.g., increasing or decreasing the advertisement according to the adjustment made to the optimal advertising period 120. Furthermore, steps 240 and 250 may be repeated whenever needed.

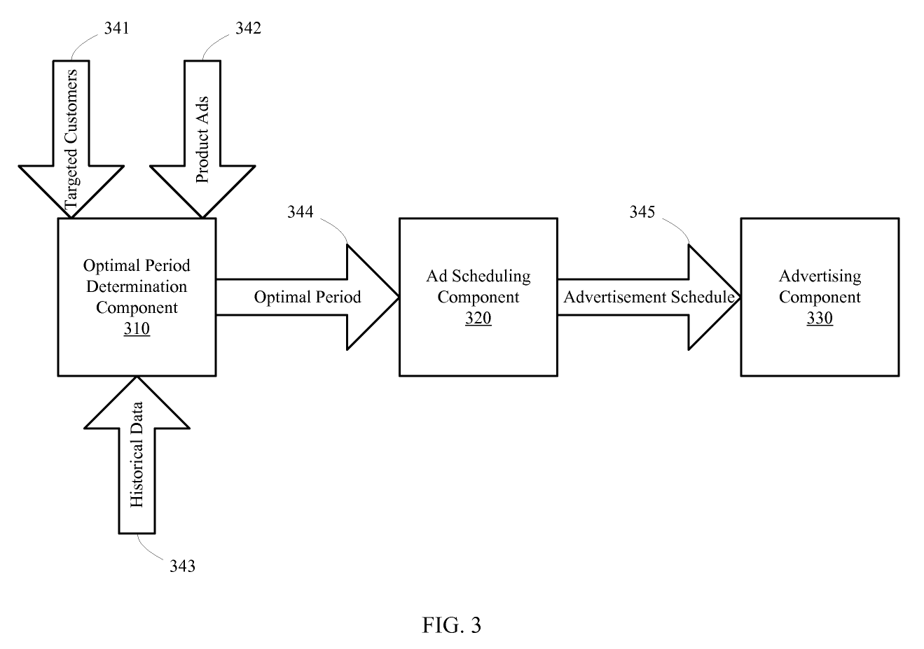

FIG. 3 illustrates a system for scheduling transient ads for a product having a viable selling period. The optimal period determination component 310 determines the optimal advertising period 120 for a product based on historical data 343 associated with other similar products, the targeted customers 341, and/or the product ads 342. The ad scheduling component 320 schedules the advertisement for the product based on the optimal period 344. Finally, the advertising component 330 conducts the product advertisement based on the advertisement schedule 345. Optionally, the advertisement schedule may be adjusted in real time based on market data collected for the product since the product has become available.

The various components shown in FIG. 3 are for illustrative purpose only. The actual design and implementation of the system may vary depending on the specific needs and requirements of the individual system. For example, various functionalities may be combined into one component, e.g., advertisement scheduling and delivery into a single component. Conversely, other functionalities may be divided into different components. Furthermore, the process may be implemented as one or more computer software programs.

Although the method has been described with respect to advertising products that have specific viable selling periods, the same concept may apply generally to other products that do not have any deadline or expiration dates as well. One or more optimal advertising periods may be determined for such products based on historical data collected for similar products and advertisement may be increased during these optimal advertising periods and decreased when outside of the optimal advertising periods.

This invention has several advantages. For example, increasing the advertising effort during the optimal advertising period is important to ad publishers who generate revenue through CPA deals. This increase during the optimal advertising period tends to result in more user actions linked to the advertisement, such as product acquisition, which in turn results in more revenue for the ad publishers. Furthermore, it may be beneficial to the advertisers as well. Sometimes, the advertisers may have a limited budget for a CPA advertising campaign, so the advertisers may wish to have the advertising efforts concentrated during the optimal advertising period so as to receive maximum results for the money spent.

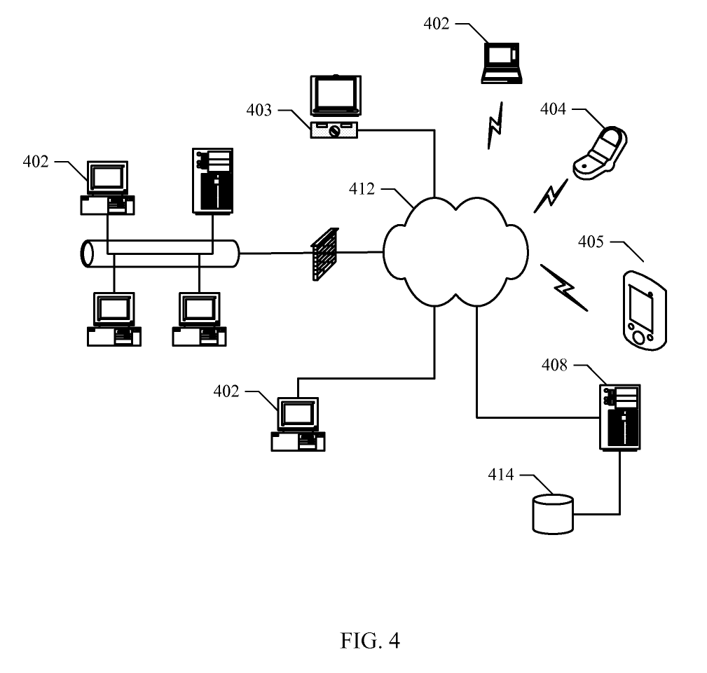

FIG. 4 is a simplified diagram of a network environment in which specific embodiments of the present invention may be implemented. It will be understood that computer software programs implementing various aspects of the invention may be executed in such an environment.

The various aspects of the invention may be practiced in a wide variety of network environments (represented by network 412) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations. All or a portion of the software program(s) implementing various embodiments may be executed on network devices represented, for example by server 408, which may represent multiple network devices distributed within the network environment.

A website may be hosted on the server 408 or by one of the computers 402, 403, and the advertising campaigns may be conducted at the website. The actual ads may be delivered via web pages. Alternatively, the ads may be delivered to the users via various devices connected to the network 412, such as personal computers 402, 403, smart phones 404, PDAs (Personal Digital Assistant) 405, etc. through emails, instant messages, and other channels.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A computer-implemented method of advertising a product between a first time when the product becomes available and a second time when the product becomes unavailable, comprising:
determining an optimal period between the first time and the second time for advertising the product;
planning an advertisement schedule for the product, such that the product is advertised more during the optimal period than other periods between the first time and the second time; and
advertising the product according to the advertisement schedule.

2. The computer-implemented method, as recited in claim 1, wherein the optimal period is determined based on historical data associated other products having similar characteristics as the product.

3. The computer-implemented method, as recited in claim 2, wherein the optimal period is determined further based on characteristics of a targeted audience to whom the product is advertised.

4. The computer-implemented method, as recited in claim 2, wherein the optimal period is determined further based on an available inventory for the product.

5. The computer-implemented method, as recited in claim 2, wherein the optimal period is determined further based on advertisements for the product.

6. The computer-implemented method, as recited in claim 1, further comprising:
adjusting the optimal period based on current data associated with the product obtained after the product is advertised; and
adjusting the advertisement schedule based on the optimal period as adjusted.

7. The computer-implemented method, as recited in claim 6, wherein the current data associated with the product is at least one selected from the group consisting of click-through rate, and purchase rate.

8. A computer program product for advertising a product between a first time when the product becomes available and a second time when the product becomes unavailable, comprising a computer-readable medium having a plurality of computer program instructions stored therein, which are operable to cause at least one computing device to:
determine an optimal period between the first time and the second time for advertising the product;
plan an advertisement schedule for the product, such that the product is advertised more during the optimal period than other periods between the first time and the second time; and
advertise the product according to the advertisement schedule.

9. The computer program product, as recited in claim 8, wherein the optimal period is determined based on historical data associated other products having similar characteristics as the product.

10. The computer program product, as recited in claim 9, wherein the optimal period is determined further based on characteristics of a targeted audience to whom the product is advertised.

11. The computer program product, as recited in claim 9, wherein the optimal period is determined further based on an available inventory for the product.

12. The computer program product, as recited in claim 9, wherein the optimal period is determined further based on adverts for the product.

13. The computer program product, as recited in claim 8, wherein the plurality of computer program instructions are operable to further cause the at least one computing device to
adjust the optimal period based on current data associated with the product obtained after the product is advertised; and
adjust the advertisement schedule based on the optimal period as adjusted.

14. The computer program product, as recited in claim 13, wherein the current data associated with the product is at least one selected from the group consisting of click-through rate, and purchase rate.

15. A computer-implemented system for advertising a product between a first time when the product becomes available and a second time when the product becomes unavailable, comprising at least one computing device configured to:
determine an optimal period between the first time and the second time for advertising the product;
plan an advertisement schedule for the product, such that the product is advertised more during the optimal period than other periods between the first time and the second time; and
advertise the product according to the advertisement schedule.

16. The computer-implemented system, as recited in claim 15, wherein the optimal period is determined based on historical data associated other products having similar characteristics as the product.

17. The computer-implemented system, as recited in claim 16, wherein the optimal period is determined further based on characteristics of a targeted audience to whom the product is advertised.

18. The computer-implemented system, as recited in claim 16, wherein the optimal period is determined further based on an available inventory for the product.

19. The computer-implemented system, as recited in claim 16, wherein the optimal period is determined further based on adverts for the product.

20. The computer-implemented system, as recited in claim 15, wherein the at least one computing device is further configured to:
adjust the optimal period based on current data associated with the product obtained after the product is advertised; and
adjust the advertisement schedule based on the optimal period as adjusted.

21. The computer-implemented system, as recited in claim 20, wherein the current data associated with the product is at least one selected from the group consisting of click-through rate, and purchase rate.
